(19) United States
(12) Patent Application Publication
(10) Pub. No.: US 2001/0032674 A1
(43) Pub. Date: Oct. 25, 2001

(54) System and method for monitoring parameters of a flowable medium within an array of conduits or pipes

(76) Inventors: Jean-Pierre Brunet, Baie D'Urfe (CA); Sami Taha, Plattsburgh, NY (US)

Correspondence Address: SWABEY OGILVY RENAULT, SUITE 1600, 1981 MCGILL COLLEGE AVENUE, MONTREAL, QC, H3A2Y3, CA

(21) Appl. No.: 09/757,594

(22) Filed: Jan. 11, 2001

Related U.S. Application Data
(60) Provisional application No. 60/178,110, filed on Jan. 26, 2000.

(51) Int. Cl. F17D 3/01

(52) U.S. Cl. 137/487.5

(57) ABSTRACT

A system for monitoring and obtaining readings of parameters of a flowable medium within a system of conduits. At least one primary flow element is located at a predetermined position in a conduit system, wherein at least one primary flow element provides an interface for obtaining at least one flow parameter of a flowable medium within the conduit system. At least one signal processing and data transfer unit is comprised of a sensor operatively connected to the at least one primary flow element for converting readings from the at least one primary flow element to an analog electrical signal. It also includes an analog to digital converter receptively connected to the sensor for converting the analog signal received from the sensor to a digital signal. A transmission unit is connected to the analog to digital converter for transmitting the digital signal upon activation of a data transfer surface of the transmission unit. A data collection unit has an activation surface for activating the data transfer surface of the transmission unit and for receiving the digital signal from the transmission unit. A data storage unit is operatively connected to the data collection unit for storing information communicated by the digital signal concerning the at least one flow parameter.

### FIELD OF THE INVENTION

The present invention relates to a method for monitoring and collecting information on the flow characteristics of a flowable medium or fluid in a conduit or pipe system. More particularly it relates to a system and apparatus for the automated monitoring, collecting and saving of such information electronically with the aid of a computer system.

### BACKGROUND OF THE INVENTION

Systems of conduits or pipes to contain and control the flow of fluids are ubiquitous in our world. Most modern structures, i.e. buildings, ships, factories, etc. rely on complicated conduit or pipe systems for a variety of purposes. These purposes include air conditioning systems, heating systems, plumbing systems, etc. The pipes or conduit systems can also form, in some instances, part of the primary industrial process itself such as those found in oil refineries and energy generating plants. All of these systems require some type of system to collect information on the flow characteristics of the gas or liquid which moves through the pipe or conduit system. A variety of reasons require the collecting of such information during “real time” operation of these systems. These include the need to make adjustments to the operation of the system, analyze the operation of the system and identify problems in the system before they interfere with its operation. Additionally, there is also the need in many instances to adjust the system for optimal operation. Generally the readings obtained from these systems include information on the pressure, the temperature, the flow rate, the relative humidity, as well as the energy generated or expended by the system. Essential to all of these monitoring systems are some type of interface which allows for the gathering and/or logging of the raw data during the real time operation of these systems. Primary flow elements provide the interface generally between the fluid medium in the conduits and the meters or other devices used to obtain the readings. The primary flow elements can be as simple as an appropriately placed opening in the conduit system into which a probe of a sensor such as a temperature or pressure gauge can be inserted for obtaining the appropriate readings. To obtain other types of readings such as flow rates of the medium in the conduit system, typically a more sophisticated structure is required such as a venturi flow element.

FIG. 1 shows a prior art pipe section depicting a venturi primary flow element. Such venturi flow elements generally consist of a specially made pipe section 120 (FIG. 1) which connects into a typical conduit or pipe system with flanges 122 and 123 at either end of the pipe element 120. The flowable medium in the example shown passes through the pipe element 120 in the direction of arrows 121. Pipe element 120 generally consists of a passage 148, coaxially aligned with an opening into the passage 136 and forms a venturi tube therebetween. The venturi tube includes a fluid inlet 150, a converging tube portion 152, a constricted throat 154 and a diverging tube portion 156. The converging tube portion 152 converts pressure head to velocity head, while the diverging tube portion 156 converts velocity head to pressure head. The constricted throat 154 produces an increase in fluid velocity accompanied by a reduction in fluid pressure. The velocity is transformed back into pressure, with a slight friction loss, in the diverging tube portion 156.

The pressure differential between a fluid inlet pressure (fluid pressure in the fluid inlet 150) and a constricted throat pressure (fluid pressure in the constricted throat 154) is a flow parameter of great significance since it permits calculation of the rate of fluid flow through the pipe element 120. More specifically, the instantaneous flow rate through the pipe element 120 is proportional to the square root of the differential pressure. A flow constant, which varies depending upon pipe size and other parameters must be utilized to determine the exact flow rates. The relationship between the pressure differential in and the rate of fluid flow through venturi tubes is well known.

Completing the venturi tube primary flow element are readout or sensing ports defined in pipe element 120. A high pressure sensing port 160 extends, through the wall of the pipe element 120, from an appropriate location in the fluid inlet 150 to an exterior location on the pipe 170. Similarly, a low pressure sensing port 161 extends, through the wall of pipe element 120, from an appropriate location in the constricted throat 154 to an exterior location on the pipe 172. As shown in FIG. 1, the high pressure sensing port 160 extends from the fluid inlet 150 through a first radially extending protrusion 162 defined in pipe element 120. The low pressure sensing port 161 similarly extends from the constricted throat 154 through a second radially extending protrusion 164 defined in pipe element 120. Caps 166 and 168 are formed with threaded shanks 170 and 172 receivable in threaded bores counter-sunk in the outer ends of the protrusions 162 and 164, respectively. The caps 166 and 168 close off the high and low pressure sensing ports when the ports are not in use. With current technology caps 161 and 162 are unthreaded and appropriate probes from a standard differential pressure meter, well known in the industry and not shown, are inserted into ports 160 and 161 to obtain the appropriate differential pressure reading. Pipe element 120 depicted in FIG. 1 also has a flow rate adjustment valve 134 with a lever 152 to facilitate adjustment of the flow. However, such a flow rate adjustment valve is not necessary for the monitoring function that the venturi tube depicted in FIG. 1 would provide.

A pitot tube is another well known form of primary flow element used as an interface to obtain various types of readings of the flow characteristics of a fluid medium flowing in a conduit system including differential pressure, which as noted above is used to determine flow rates. U.S. Pat. No. 4,823,615 (The inventor of this patent being one of the inventors herein.), which is incorporated herein by reference and made a part hereof as if set forth herein at length, describes such a pitot tube probe and the manner in which it is used to obtain information on the flow characteristics of a fluid medium within a pipe or conduit system.

The typical conduit or pipe system has numerous primary flow elements positioned at various preselected points, flow parameter collection locations, sometimes referred to as stations herein, within the system to obtain readings of flow characteristics of the fluid circulating in the system. To date, substantial efforts have been made to standardize and improve the collection and maintenance of information on the flow characteristics of conduits and pipe systems. A number of the disclosed systems provide for the taking of readings of flow characteristics at various locations in the pipe system. A number also use devices with microprocessor or computer based systems to obtain these readings. Systems also exist which provide individual units to be positioned at flow parameter collection locations and which in at least one instance can be programmed, and transmit data via cable connection, or wireless.

However none of the existing systems used to measure and gather or log information on the flow characteristics of a fluid medium within a conduit system provided a simple, economical and efficient system which can be operated and maintained without a high degree of skill and knowledge. Additionally, none of the disclosed systems provide a simple and efficient system which does not need a separate power source to run the local units located at flow parameter collection locations. Nor do any of the currently disclosed systems allow them to quickly and easily be retrofitted or installed onto existing primary flow elements within an existing pipe or conduit system. Thus what is needed is an economical and efficient system for monitoring and gathering information on the flow characteristics of a fluid medium within a pipe or conduit system. A system that can easily and efficiently be adapted to and function with existing primary flow elements of most conduit or pipe systems. A system in which the local collection units do not need a separate power source and which allows the gathering of readings from a local meter in a quick and efficient manner.

### SUMMARY

It is an objective of the present invention to provide an expeditious, economical efficient method for collecting information on the flow parameters of a conduit system.

It is another objective of the present invention to provide a system which is easy to maintain and be use by individuals with limited technical training.

It is yet another objective of the present invention to provide a system which can easily be adapted to existing primary flow elements of a conduit or pipe system or retrofitted onto existing conduit systems.

It is another objective of the present invention to provide a system and method that does not need a separate power source for the local flow parameter collection meters.

It is still another objective of the present invention to provide a system that allows for the obtaining of readings from a local unit by merely touching a contact point and transmitting data via wireless communication.

The invention accomplishes these and other objectives by providing a system for monitoring and reading parameters of a flowable medium within a system of conduits consisting of: one or more primary flow elements located at predetermined positions in a conduit system, the primary flow elements providing an interface for obtaining flow parameters of a flowable medium within the conduit system. The system has signal processing and transfer units located at each predetermined position. The signal processing and data transfer units having: a sensor operatively connected to an adjacent primary flow element for converting readings from the primary flow element to an analog electrical signal; an analog to digital converter receptively connected to the sensor, for converting the analog signal received from the sensor to a digital signal; and a transmission unit connected to the analog to digital converter for transmitting the digital signal upon activation of a data transfer surface of the signal processing and data transfer unit. A data collection unit having an activation surface for activating the data transfer surface of the transfer unit and for receiving the digital signal from the transfer unit; and a data storage unit (logger) operatively connected to the data collection unit for storing information communicated by the digital signal concerning the flow parameters.

The invention also provides a method for monitoring and collecting information on flow parameters of a flowable medium in a system of conduits, said method comprising the steps of: a) programming a signal processing and data transfer unit with pre-selected data regarding a specified primary flow element of a conduit system; b) operatively attaching said signal processing and data transfer unit programmed with the pre-selected information at a flow parameter collection locations, which location has said specified primary flow element for which said signal processing and data collection unit was programmed; c) providing power with a data collection unit to said signal processing and data transfer unit so that said signal processing and data transfer unit will generate readings; and d) collecting readings generated by said signal processing and data collection unit regarding flow parameters from said data processing and signal transfer unit.

In additional aspect of the method of this invention the step of programming said signal processing and data transfer unit further comprises programming a plurality of signal processing and data transfer units with pre-selected data regarding a plurality of specified primary flow elements so that the programmed data on each signal processing and data transfer includes information regarding a unique one of each of said primary flow elements and said step of attaching said signal processing and data transfer unit comprises attaching it to said unique primary flow element for which it has been programmed.

### BRIEF DESCRIPTION OF THE DRAWINGS

The invention will be better understood by an examination of the following description, together with the accompanying drawings, in which:

FIG. 1 provides a side view of a pipe section of the prior art which depicts a venturi primary flow element;

FIG. 2 is a schematic diagram of a portion of a conduit system on which the signal processing and data transfer units of the present invention have been installed;

FIG. 3 is an overall schematic diagram of the functional components of the present invention;

FIG. 3A is a diagram of a pipe section with primary flow elements on which a signal processing and data transfer unit of the present invention had been installed;

FIG. 4 is a block diagram of the signal processing and data transfer unit of the present invention together with a primary flow element;

FIG. 5 is a block diagram of the sensor functions of the present invention;

FIG. 6 is a flow chart of a calibration and initialization program used to prepare the signal processing and data transfer units for operation;

FIG. 7 is a flow chart of the meter interrogation program;

FIG. 8 is a flow chart of the data review and analysis program;

FIG. 9 is a detailed block diagram of the functional components of the signal processing and data transfer unit;

FIG. 9A is a schematic block diagram of one version of a preferred embodiment of the signal processing and data transfer unit; and

FIG. 10 is a schematic block type diagram of a conduit system containing various signal processing data transfer units located at flow parameter collection locations and connected into a modified local area access network.

### DETAILED DESCRIPTION OF THE PREFERRED EMBODIMENT

### 1. Overview of the System

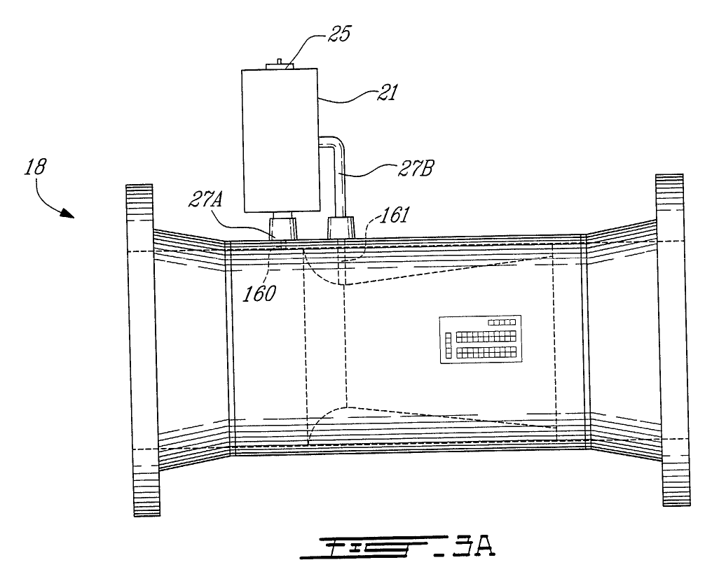

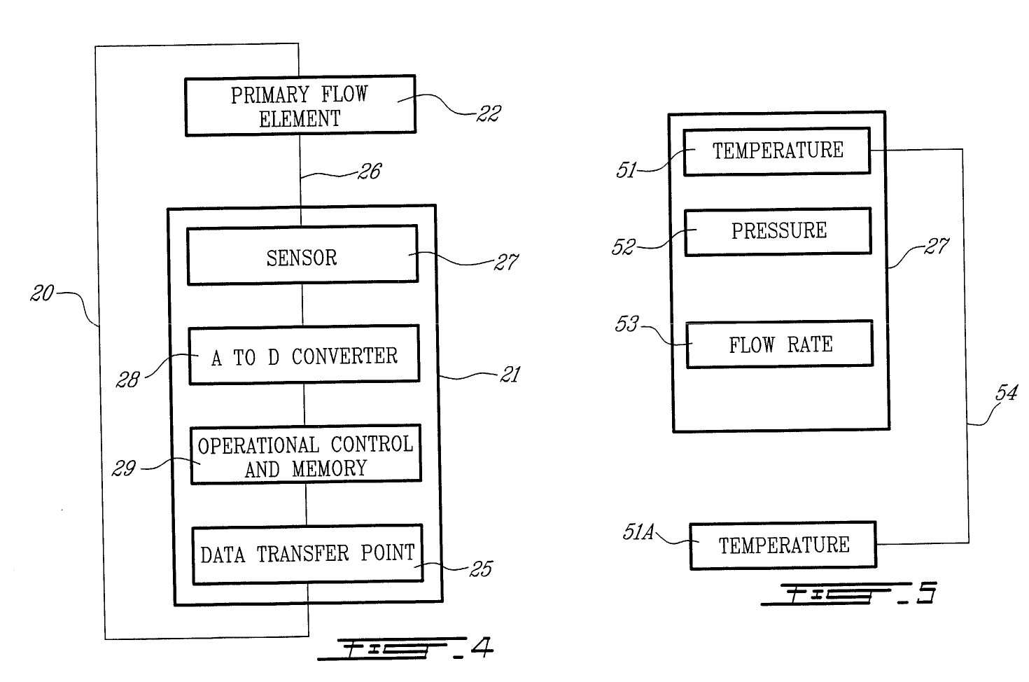

The invention provides a system for monitoring the flow of a liquid or gas within a system of conduits or pipes. It monitors for the following parameters: 1) pressure; 2) temperature; 3) flow rate (generally determined from a differential pressure reading); and 4) heat loss or production depending upon the purpose. At selected points in the pipe or conduit array 19 (FIG. 2) meters 20 are positioned to monitor one or more of the relevant parameters, i.e. temperature, static pressure and differential pressure. FIG. 3 depicts a number of the various local meter units 20A, 20B, 20C, 20D and 20E which can be strategically positioned around the array of conduits or pipes. Each of the local meters 20 A-E has a primary flow element or component 22A, 22B, 22C, 22D and 22E and signal processing and data transfer unit 21A, 21B, 21C, 21D and 21E.

FIG. 3A provides a detailed view of one of the meters 20A in which probes 26A and 26B from a sensor (To be discussed in detail below.) located in the signal processing and data transfer unit 21 can obtain access to the flowable medium in pipe section 18 through high pressure sensing port 160 and low pressure sensing port 161. This provides one example of how the primary flow elements 22 act as an interface and allow the gathering of readings from which the temperature, static pressure and differential pressure can be determined. The differential pressure is calculated from readings obtained at the high pressure sensing port 160 and low pressure sensing port 161. The temperature reading could be obtained form either port 160 and 161. The static pressure reading could be obtained from port 160. The arrangement for gathering readings would be similar for meter 20A which is equivalent to that described in U.S. Pat. No. 4,823,615 cited above, as well as meters 20B, 20C and 20D.

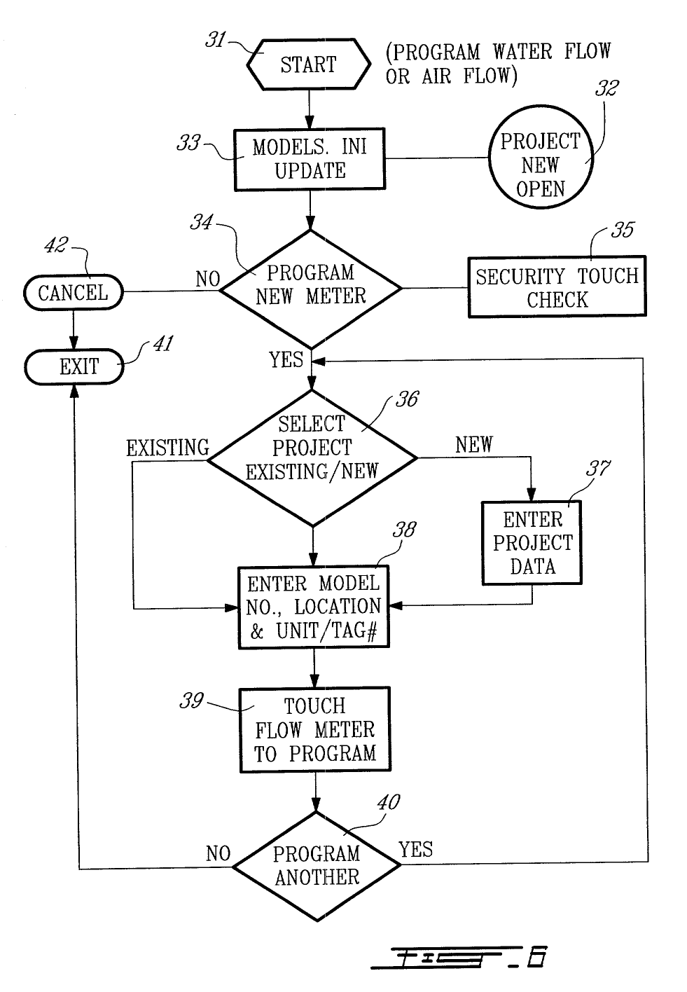

FIG. 4 is a block diagram of the major functional components of the local meter 20. A probe 26 from the signal processing unit 21 connects to primary flow element 22. Within the signal processing unit 21 are sensors 27 which take the raw readings obtained by the probe 26 from the primary flow element 22 and converts them into an electrical signal. In turn the electrical signal, in analog form, is converted to digital signal by analog-to-digital converter 28. An appropriately confined operational and control device 29 receives the digital signal, processes it and then transfers it to a data collection unit when an appropriate transfer probe 23 is attached to the data transfer point 25. In the preferred embodiment the signal processing and data transfer unit 21 would receive its power from the data transfer probe 23 when connected at the data transfer point 25. The data transfer probe 23 provides power to the entire signal processing and data transfer unit 21 during the period of time the probe 23 is in contact with the data transfer point 25 of the signal processing unit and data transfer unit 21.

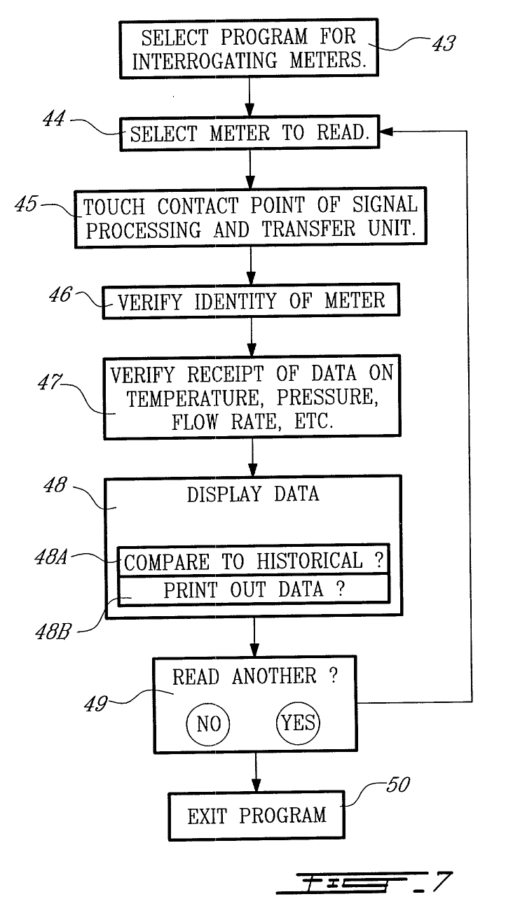

FIG. 5 is a block diagram of the various sensor devices which make up the sensor 27. In the preferred embodiment it includes a temperature sensor 51, a pressure sensor 52 and a flow rate sensor 53. The flow rate sensor is in fact a differential pressure sensor the readings from which are used to calculate the flow rates. Additionally, a remote temperature probe 51A on line 54 can be added to take a simultaneous temperature reading at a different position in the array of pipes. This would allow for a calculation of energy generation or loss in units, such as BTU's, used or produced over the section of the system that the temperature difference is taken.

A portable lap top computer 24 FIG. 3 acts as the data receiving unit, the data storage unit and the analysis unit when running appropriate software. As noted above data is transferred to the computer 24 when a comport touch wand or comport snap-on wand 23 is pressed against the data transfer point 25. The touch wand or snap-on wand 23 would connect into the computer 24 through a standard serial comport with an RJ-11 connector 23A. The RI-11 connector attaches to the 9 pin serial port on data collection unit 24. Although the preferred embodiment uses a lap top computer to gather the information from each of the meters 20 it will be appreciated that special portable interrogation units can be made to gather the information, and the interrogation units after collecting the readings would be connected to central computer system for down loading, analysis and storage of the information collected. Large refinery operations, very large buildings with huge pipe systems to monitor are among the operations that might employ this alternative. A regular PC computer could also be used in particular one located on a LAN as will be discussed below.

The preferred embodiment of the present invention uses a 1-Wire® technology produced by a Dallas Semiconductor Corporation. This company produces a patented one wire touch technology which includes various semiconductor chips which make up the operational control and memory unit 29 used in the present invention. These chips, as will be discussed below, are incorporated into the signal processing and data transfer units 21. Wand 23 also contains a comparable chip and data collection unit 24 uses software, as will be discussed below, which together with the wand 23 activates and communicates with the signal processing and data transfer units 21 to program units 21 or take readings from units 21. Thus, when data transfer surface 25 is touched by touch wand 23 the units while in contact exchange information. The wand 23, in the preferred embodiment also provides power to the signal processing and data transmission units 21. Once the concepts of the present invention are understood by an average person skilled in the art it will be readily apparent that the system of the present invention could be implemented in other ways without the 1-Wire® technology and that a system which accomplishes the same result can be made.

### 2. Software Programs

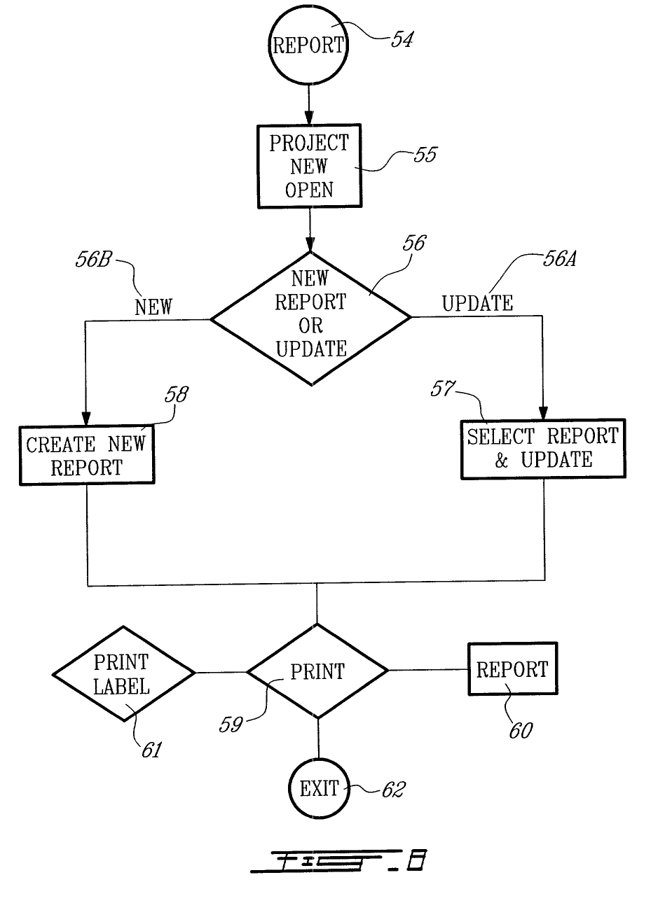

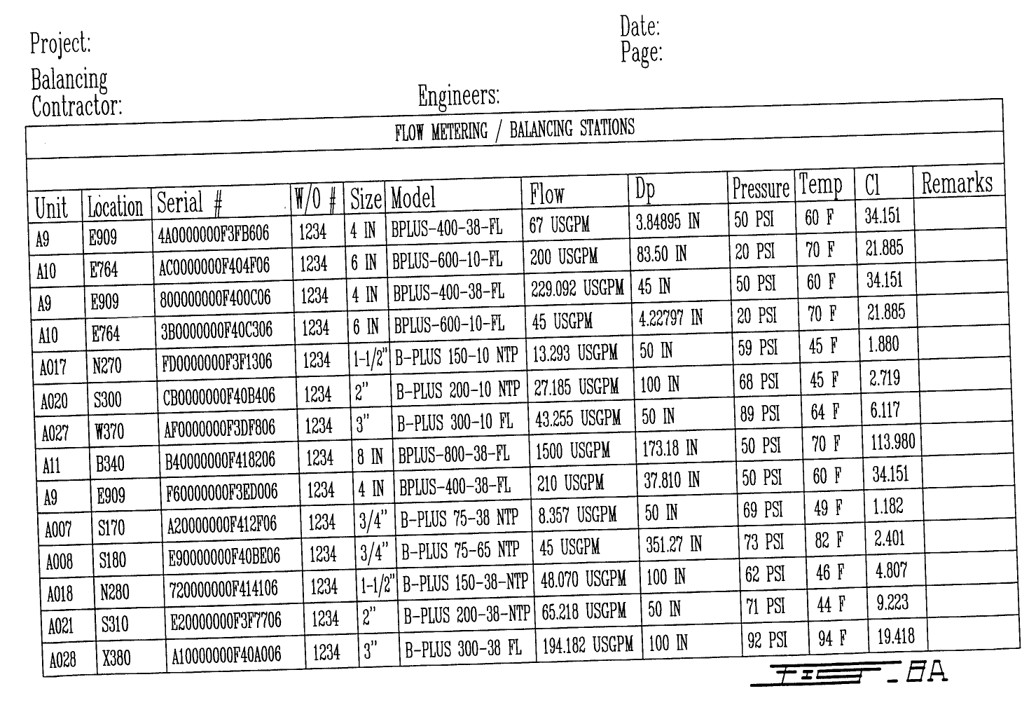

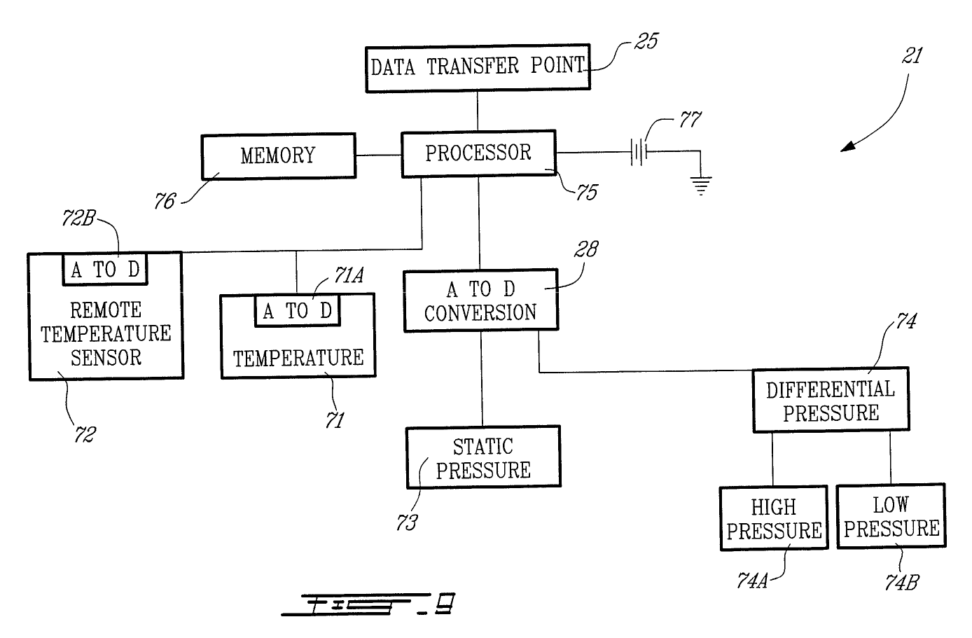

The invention has three basic software programs which function in conjunction with the other components of the invention. FIG. 6 is a flow chart of the set up initialization and calibration program. FIG. 7 is a flow chart of the customer operating and read program which is used to take readings from each of the meters. FIG. 8 is a flow chart of the customer administration and analysis program. All of this software in the preferred embodiment runs on the data collection unit 24.

The flow chart in FIG. 6 shows the process used to set up the software and calibrate the signal processing and transfer units 21. Given the differences between the flow of gas and water, there would be separate programs for each. Thus one of the initial decisions at the start 31 is determining which program is appropriate. After starting the software 31, at the next step 33 information is entered regarding the meters to be calibrated and the project with which they will be used. If it is a new project, information is then entered 32 regarding this new project. At step 33 information on the models of each of the meters being used plus their individual characteristics are entered into a calibration database. The information entered includes: 1.) Identification of each of the sensors 27 and their characteristics as well as information on the signal processing and data transfer unit. 2.) Information on the flow constants which the system would need to calculate the flow rate from the readings of the differential pressure as noted above. Each primary flow element as discussed above has its own different flow constant based on a number of factors including the size of the pipe, etc. 3.) The information entered also includes information needed on the transducer units which form part of the sensors 27 used for measurement of static pressure and differential pressure. Such information would include information on how linear a reading the transducer produces and its hystersis etc.

The next step 34 initiates the program new meter section of the software. At this point two decisions are made: 1.) Will a meter be programmed, and 2.) will a security access code be added. If the decision is made not to program specific meters than the program is canceled 42 and exited 41. If the decision is made to program a new meter then the project is selected at step 36. At this point if it is an existing project than the next step 38 is identifying the project and entering the information on the meter and touching 39 with the wand 23 the contact point 25 of the signal processing and data transfer unit 21 to program it. Information entered at step 33 is used to program the signal processing and data collection units 21. The program depicted in the flow chart of FIG. 6 would typically be running on a standard desk top or lap top PC 24, FIG. 3. Programming of each of the signal processing and data transfer units involves the reverse of the process of reading the meters. Touch or snap-on wand 23 connects to computer 24. Programming occurs when touch or snap-on wand 23 touches the contact point 25 of the signal processing and data transmission unit 21.

If several units have to be programmed than the subroutine of steps 40, 36, 38 and 39 is run until all of the meters have been programmed. On the other hand if it is a new project for a particular customer than the information on the new project is entered 37. The meters are then programmed by running through the subroutine 38, 39, 40 and 36 until all meters needed have been programmed at which point the program is exited 41.

In the preferred embodiment once the units 21 are installed at a flow parameter collection location or station in a pipe or conduit system the units 21 would be monitored and information down loaded from them with a separate read meter program depicted in FIG. 7. The read meter program would be either for a liquid flow or gas flow system and running on the computer 24, FIG. 3. Although the actual programs would differ, given the different parameters of the flow of gas and liquid, the functioning of each program would be the same. The software would be started on computer 24 by selecting the appropriate program 43 (FIG. 7). The first meter is selected 44 and touched 45 and if the program recognized it as a meter of an existing project 46 the system would save the reading and output it to a display. If the program did not recognize the meter as being associated with an existing project the user is-prompted to enter information for the new project.

The program would verify receipt of the data 47 and then display it 48 on computer 24. The operator would have the option of viewing the data in an historical context with the previous maximums and minimums 48A. The operator may, if a printer is available print out the information 48B. The next decision is whether or not another meter should be read at step 49. If the decision is made to read another, the operator then the runs the subroutine of steps 44, 45, 46, 47, 48 and 49 until all of the meters in the system have been interrogated or read.

As will be discussed in detail below the readings transferred by the signal processing and data transfer units 21 to the data collection unit 24 are saved in a report program.

In the preferred embodiment of the present invention an actual reading is not saved on the data collection unit 24 while the touch wand 23 remains in contact with the data transfer point 25. The readings are saved when the wand 23 breaks contact with the data transfer point 25. The data collection unit 24 saves the last readings sent by the signal processing and data transfer unit 21 before contact was broken. Also, in the preferred embodiment the signal transfer and data processing unit 21 takes the average of five consecutive samples and sends the average as the reading to be saved on the data collection unit 24. Naturally, the signal processing and data transfer unit 21 is capable of being programmed to compute average readings on larger or smaller sample groups or of sending multiple readings to the data collection unit 24.

FIG. 8 is a flow chart of a program used in the preferred embodiment to review the data obtained and prepare reports using the data collected. The report program in which the readings are saved also includes the capability of allowing the user to view the data and prepare reports. To view that data the viewer would request a report after the report program is started 54. The user would be prompted to select an existing project or a new one 55. If the user responded that it was an existing project 56 the user would then be prompted to identify it and then up date it with any new information 57 collected. If it is a new project the user would be prompted to enter the information on the new project so the report could be prepared based on new data obtained 58. Once the report has been prepared in addition to viewing it the user would have the option 59 of printing a copy of the report 61 and a label 60. Once done the user would exit the program. The program also has the option for transferring the data to another program such as Excel® for viewing, analysis, manipulation, etc. This would give the user many more options for use the information given the capabilities of such a program.

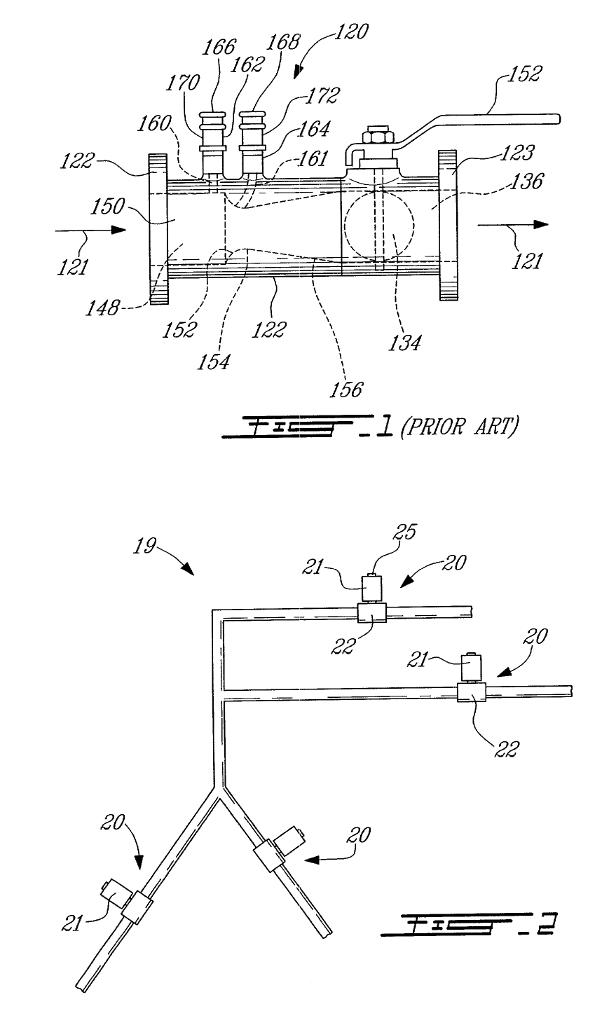

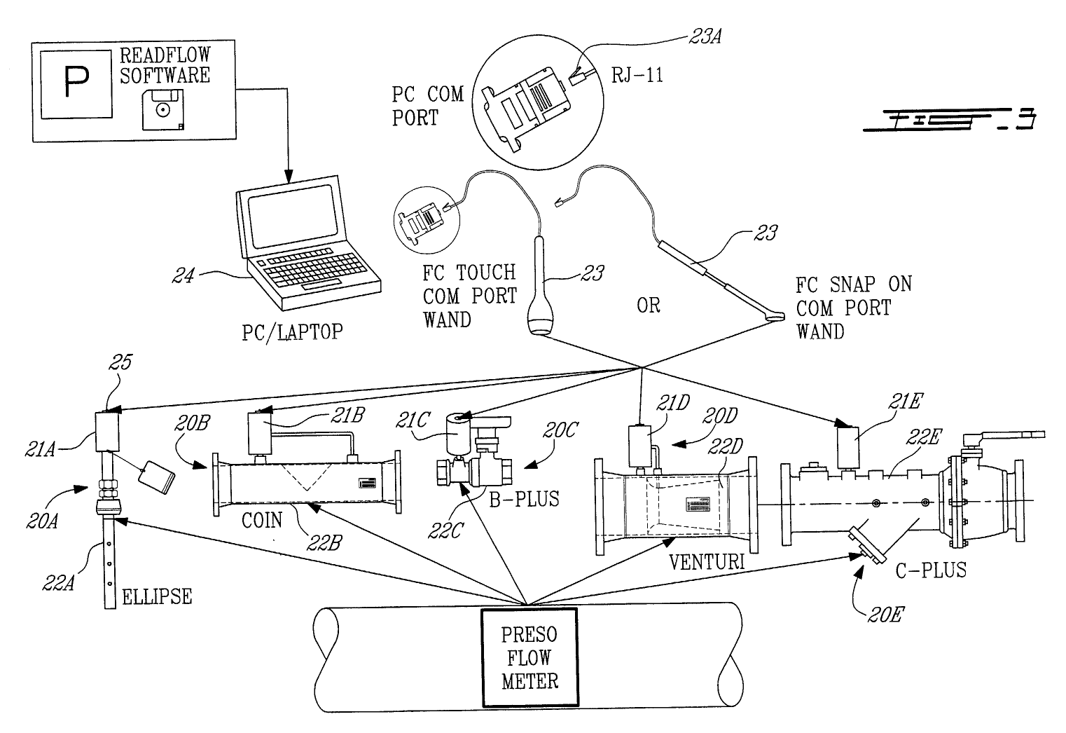

FIG. 8A presents a portion of one type of report which the present invention would produce and which can be prepared for viewing on a computer screen and/or printed out using the report program of the invention or Excel®. The report includes: (1) information designating the type of station or unit (“Unit”) at which the signal processing and data collection unit 21 is disposed (Station being synonymous with the term flow parameter collection location.); (2) information designating the location (“Location”) of the station in the conduit system; (3) the serial number (“Serial #”) of the signal processing and data transmission unit at the identified station; (4) information designating a work order number (“W/O #”) associated, for example, with the present or most recent readings taken; (5) the size (“Size”) of the pipe, or sizes of the pipes, utilized at the identified station; (6) information designating the type of primary flow structure used at the identified station; (7) the present or most recent calculation of the instantaneous fluid flow rate (“Flow”) through the identified station; (8) the present or most recent differential pressure reading (“DP”) taken at the identified station; (9) the static pressure (“Pressure”) reading obtained at the identified station (This could be taken via the high pressure sensing port 160, a separate pressure plug, or some other appropriate device.); (10) the present or most recently obtained temperature (“Temp”) of fluid passing through the identified station, (11) the value of the flow constant (“C₁”), which depends, among other factors, on the pipe size or sizes and the balancing valve model, used to determine the exact flow rate in the primary flow elements at the identified station (As noted above the flow constant is included in the program which reads and analyzes the information.); and (12) any remarks (“Remarks”) relating to the station that a user deems necessary or pertinent. The report shown in FIG. 8A facilitates monitoring of the flow parameters and other parameters acquired at all stations in the conduit system. The effects of adjusting the flow of fluid through a station, through use of a valve such as that shown in FIG. 1, on the conduit system as a whole can be also efficiently determined by comparing reports similar to that in FIG. 8A from before and after the adjustment. The effects of adjusting fluid flow through any of the stations in a conduit system, where that station allows for the adjustment of flow, on the fluid flow through the other stations can easily be determined with this and similar reports after the necessary readings have been gather from each of the stations. All flow parameters and other parameters acquired by a user as the user travels from station to station in the conduit system with data collection unit 24 and attached probe 23 are saved in the database of flow parameters. The manner in which this is accomplished is clear from the preceding description when considered in conjunction with the following.

Other types of reports can just as easily be generated, for example the system could generate a history of readings of flow parameters taken at a specific station. As noted above and discussed below, the data can be transferred to standard spreadsheet programs which would allow a wide variety of options for the viewing, analysis and manipulation of the data.

### 3. The Sensing Devices

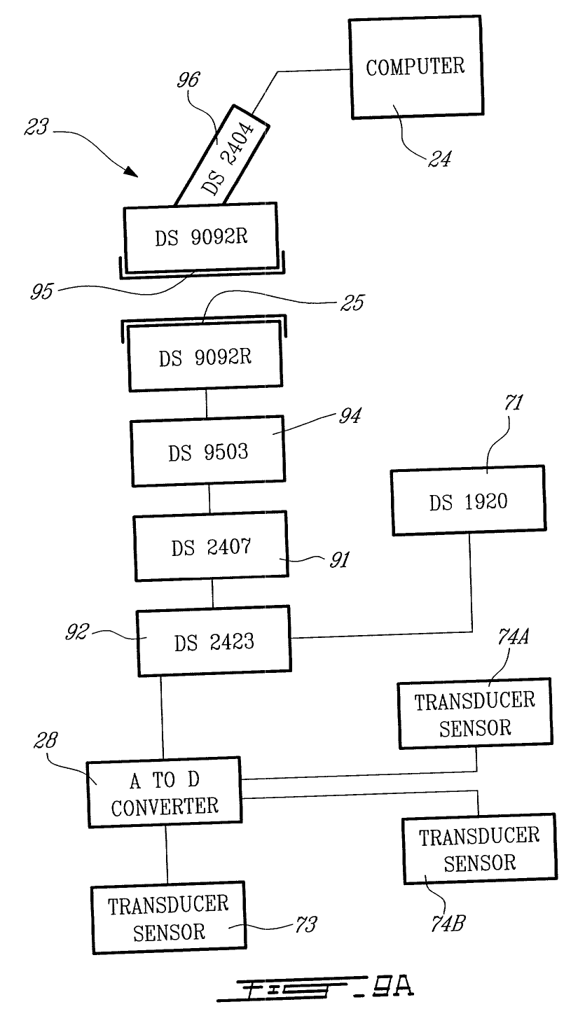

The system of the present invention would use standard sensors for obtaining readings for the temperature, static pressure and differential pressure. Any number of currently available temperature probes could be used. In the present invention a temperature probe which produces a digital signal 71 (FIG. 9) is used. The sensor 71 includes its own analog-to-digital conversion unit 71A. The remote sensor 72 which may also be used by this system would also have its own analog-to-digital conversion unit. The preferred embodiment of the present invention uses a 1-wire digital™ thermometer made by Dallas Semiconductors designated as the DS1920 touch thermometer chip. The sensing portion of the thermometer chip would naturally obtain access to the fluid through the appropriate openings of primary flow elements similar to that depicted as 160 and 161 in FIG. 3A. Thermocouples, resistive temperature difference device (RTD) and other type of similar devices could be used in the invention to obtain the necessary temperature readings.

The static and differential pressure sensors in the preferred embodiment use a piezoresistive technology. The sensors in effect are transducers. Typically such sensors or transducers use four identical piezo-resistors embedded in or positioned on the surface of a silicon diaphragm. Pressure applied to the thin diaphragm will induce a strain on the diaphragm. In a typical piezoresistive structure, semiconductor strain-gages are set up as four resistors in a whetstone bridge arrangement. Thus, a signal voltage generated by the wheatstone bridge arrangement of the four resistors is proportional to the amount of supply voltage and the amount of pressure applied to the gage which generates the resistance change. The static pressure sensor 73 (FIG. 9) would use such a piezoresistive strain-gage. The strain-gage used for the static pressure reading could obtain access to the fluid through a sensing port similar to 160 (FIG. 3A). Differential pressure would be obtained with similar types of piezoresistive strain-gages. Naturally there would be two separate ones, one for the high pressure 74A sensor and one for the low pressure sensor 74B. the high pressure sensor 74A would extend through high pressure sensing port 160 (FIG. 1). The low pressure sensor 74B naturally would extend through low pressure sensing port 161 (FIG. 1). The signals produced by the static pressure sensor 73 and differential pressure 74 would be converted from an analog to a digital signal by analog-to-digital conversion unit 28 (FIG. 9). Part of the programming process discussed above with respect to FIG. 6 and below with respect to the signal processing and data transfer unit 21 involves adjusting a variable resistor on the transducer to assure it provides accurate readings. Other types of pressure sensors could be used without departing from the spirit of the invention including strain gages, capacitor type transducers and diaphragm type transducers.

### 4. The Signal Processing and Data Transfer Unit

FIG. 9, described in part above, provides a more detailed block diagram of the functional components of the present invention which make up the signal processing and data transfer unit 21. The sensors 71, 72, 73 and 74 have been described above in detail. The entire unit would function around processor 75 which would, upon activation, obtain readings from each of the sensors 71, 72 (assuming it is being used), 73 and 74. The processor 75 would then transmit through the data transfer point 25 specific information identifying the unit 21 (this most likely would be a specific assigned serial number) together with the temperature, static pressure and differential pressure readings. As noted above in the preferred embodiment the system would receive power to generate these readings when the appropriate wand 23, depicted in FIG. 3, activates data transfer point 25. Also as noted above, each of the signal processing data and transfer units 21, depicted in FIG. 9, would be programmable. During the programming process as described above and depicted in FIG. 6, the programmed information would be stored in memory 76 (FIG. 9) and battery 77 would provide the necessary power to prevent loss of the programmed information in memory 76. Alternatively, the unit could be programmed such that it would have its own stand-alone power source 77 which would provide enough power for the system to allow processor 75 to take periodic readings as programmed for in the memory 76 and then save those readings in the memory 76. This would all be done without any activation through data transfer point 25. Thus, in this alternative version, when data transfer point 25 is activated for transfer of the information, the processor not only would provide real time readings, but also download to the data collection unit 24 saved readings of the temperature, static pressure and differential pressure taken over a period of time.

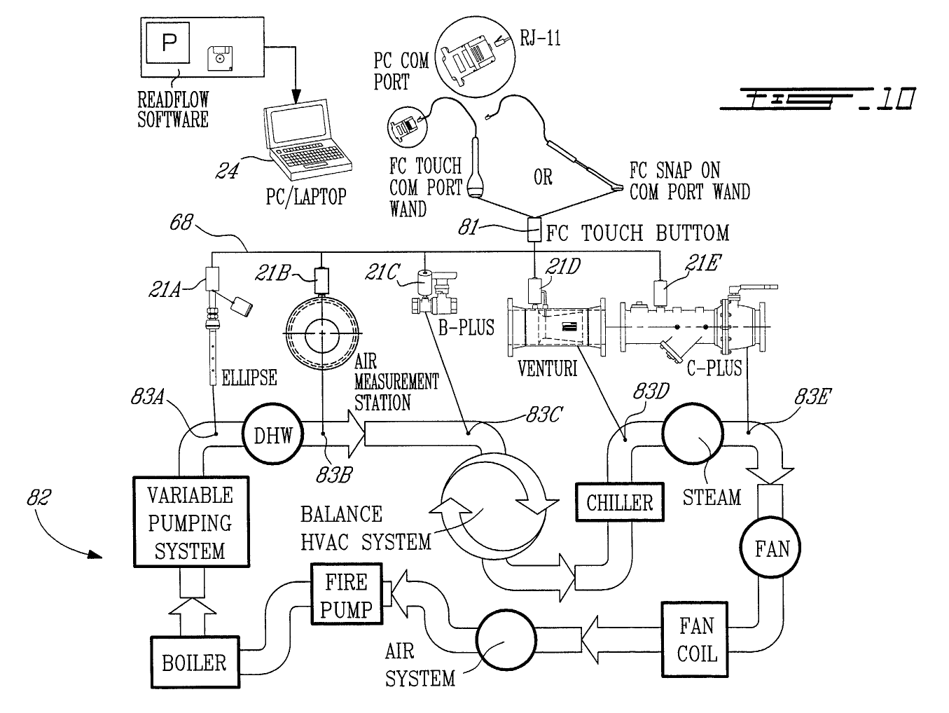

Alternatively, a number of these units 21 as depicted in FIG. 10 could be connected to a central unit 81 by a common communication line 68. Thus information from one connection between wand 23 and the contact point 25 at signal collection and data transfer unit 81 would allow for the transmission of data from various signal processing and data transferring units 21 A-E on line 68 located around a conduit system 82. When each one of the units 21 A-E transmits, the information obtained from at their flow parameter collection locations 81 A-E, they each would include an identifying serial number or other identifying information which would allow the central collection unit 24 to identify which signal processing and data transfer unit 21 A-E at a particular station or flow parameter collection location 83 A-E sent the information.

As noted above, the preferred embodiment of the present invention uses various semi-conductor chips produced by Dallas Semiconductors Corporation. The processor and memory functions discussed above in the preferred embodiment would be handled by Dallas Semiconductor chips designated DS-2423 item 92 (FIG. 9A), DS-2407 item 91 and item 94 DS-9053 item 94. The Dallas Semiconductor DS 2423 is a RAM with counter which allows for reading of any type of meter remotely, as well as providing a unique identification. The DS -2407 contains two bidirectional I/O ports that are controlled with a single port pin by a host microprocessor (data collection unit 24) using the Dallas Semiconductor 1-Wire® Dallas Semiconductor chip 94 designated DS 9593 is and ESD protection diode with resistors. The diode having zener characteristics with voltage snap-back to protect against ESD. The data transfer point 25 on the signal processing and data transfer unit having the Dallas Semiconductor chip designated DS 9092R chip. Likewise data receiving point 95 on touch wand 23 is the Dallas Semiconductor chip designated DS 9092R chip. The analog-to-digital conversion function could be handled by any standard chip or chips 28 available on the market. Standard types of sensors or transducers 73, 74A and 74B such as ones manufactured by the Honeywell Corporation could be used as the sensors or transducers. As noted above the temperature sensor 71 is a Dallas Semiconductor DS 1920. The touch wand 23 might also have a Dallas Semiconductor DS 2402 chip 96 to support the touch protocol to act as an interface between the contact point 95 and computer 24. The system can be designed to take readings of flow parameters every 700 milliseconds.

The preferred embodiment as noted uses the Dallas Semiconductor system as a matter of convenience since the system, given it features and unique 1-Wire® technology, is suited to the purposes of the invention. However, the system and method of the present invention could be implemented by use of an appropriate dedicated or general purpose processor together with memory chips and input output devices given the programmable nature of the invention as generally depicted in FIG. 5. In fact it could be done without any battery 78 with an appropriate memory device 76 which would not require a battery to maintain the memory. Power to operate the signal processing and data transfer unit 21 would be supplied by data collection unit 24 or a separate appropriately configured portable power supply which could accompany the data collection unit 24. A simple appropriately configured contact surface or point 25 could be used to transfer power to unit 21 while unit 24 receives the readings generated. Naturally, the software would function the same as above and implemented through standard techniques.

### 5. The Data Collection Unit

In the preferred embodiment the system uses a standard laptop computer running Windows 98 as the data collection unit 24. The signal processing and data transfer unit 21 transmits the readings obtained from the sensors in an ASCII format to data collection unit 24. Consequently, any number of different communications protocols such as dynamic data exchange (DDC), object linked embedding (OPE), or object linked embedding for process control (OLE-OPC) can be used by data collection unit 24 to receive the readings and transfer them to the report program with which the data will be viewed, saved and manipulated.

To add utility to the current invention and make it much more functional the current invention allows the user, as noted above, to transfer the data saved in the report program to a standard spreadsheet programs such as Excel®. Given the extremely broad capabilities of standard spreadsheet programs the user will have substantial capabilities to manipulate the data, analyze and display the data in various tabular or graphical forms. Other spreadsheet programs which the data can be transferred to for viewing, manipulation, analysis and storage are Quattro Pro®, Lotus 123® etc. Additionally, the data can be transferred to any of the following programs for viewing, storing and manipulating the readings such as: Word®, Wonderware®, In Touch®, Labview®, Test Point®, Visual Basic®, Borland Dephi®, etc.

In the preferred embodiment each of the signal processing and data transfer unit 21, as noted above, is programmed for: a) a specific identifying serial number, b) a number of key factors used to calculate the differential pressure which include the flow constant, pipe size, etc. and c) calibration information for the transducers which may include a proper voltage setting, etc. However, data collection unit 24 does the actual calculations for the flow rate using the differential pressure readings taken by the signal processing and data transfer unit 21 The data collection unit 24 uses standard equations based on Bernoulli's Theorem (Energy Balance). They include common forms as follows:

1. Liquid

$$Δ P = {( \frac{GPM}{{C}_{1}} )}^{2} {SG}_{f}$$

C₁=5.6660·K ·Dᵢ²·Fₐ

2. Gas/Air;

$$Δ P = {( \frac{SCFM}{{C}_{1}} )}^{2} \frac{{SG}_{s} ( {T}_{f} + 460 )}{{P}_{f}}$$

C₁=128.8·K·Dᵢ²·Fₐ

Note: SCFM=ACFM·P_{f}/14.73·520/T_{f}+460

3. Steam:

$$Δ P = {( \frac{Lbs / Hr}{{C}_{1}} )}^{2}$$

C₁=359·K·Dᵢ²·Fₐ·√P_{f}

Where:

ΔP=The differential pressure as measured in inches of a water column at 68° F. and sea level.

GPM=US Gallons Per minute.

SCFM=Standard cubic feet per minute at 70° F. at 14.73 psia.

ACFM=Actual cubic feet per minute.

Lbs/Hr=Pounds mass per hour.

C₁=Flow constant.

K=Flow coefficient.

Dₗ=Inside pipe diameter in inches.

Fₐ=Thermal expansion of the pipe; up to 100° F./100.1-1.005 (100-500° F.).

T_{f}=Flowing temperature, ° F.

P_{f}=Flowing pressure, psia.

SG_{f}=Specific gravity at flowing conditions.

SGₛ=Specific gravity at standard conditions (70° F., 14.73 psia).

P_{f}=Flowing density, lbs./ft³.

The proceeding provides one basis for calculating the flow rate. Variations could be made to the above and appropriate results still achieved. It should be noted that the flow coefficient can be calculated in a standard fashion for different probe and pipe sizes.

Temperature and static pressure are easily calculated based on the specification for the sensors used for measuring each. Naturally, the above would be programmed in standard fashion into the data collection unit which as noted has all of the standard features including memory on which to store the database of flow parameters saved

### Conclusion

Thus, the present invention provides a system and method for obtaining readings from programmable meters with one touch of contact points. The local signal processing and data transfer units do not need an independent power supply since power is provided by the data collection unit. This facilitates placement of meters in remote and difficult to access locations. The signal processing and data transfer units are programmable units which can be easily programmed to work with conduit systems that carry gas, liquid, etc. The system of the present invention can be operated by individuals with little or no special technical skills or training.

While the invention has been particularly shown and described with reference to a preferred embodiment thereof, it will be understood by those skilled in the art that various changes in form and detail may be made to it without departing from the spirit and scope of the invention.

We claim:

1. A system for monitoring and obtaining readings of parameters of a flowable medium within a system of conduits comprising:
a) at least one primary flow element located at a predetermined position in a conduit system, wherein at least one primary flow element provides an interface for obtaining at least one flow parameter of a flowable medium within the conduit system;
b) at least one signal processing and data transfer unit comprising:
1) a sensor operatively connected to said at least one primary flow element for converting readings from said at least one primary flow element to an analog electrical signal;
2) an analog to digital converter receptively connected to said sensor for converting said analog signal received from said sensor to a digital signal; and
3) a transmission unit connected to said analog to digital converter for transmitting said digital signal upon activation of a data transfer surface of said transmission unit;
c) a data collection unit having an activation surface for activating said data transfer surface of said transmission unit and for receiving said digital signal from said transmission unit; and
d) a data storage unit operatively connected to said data collection unit for storing information communicated by said digital signal concerning said at least one flow parameter.

2. The system of claim 1 further comprising a computer to analyze said information stored in said data collection unit.

3. The system of claim 2 wherein a plurality of digital signals are received and parameters from each signal are saved in a database of flow parameters.

4. The system of claim 1 wherein said at least one primary flow element is a plurality of primary flow elements at various predetermined positions wherein each of said plurality of primary flow elements provides an interface for a sensor to obtain a flow parameter at said predetermined position.

5. The system of claim 4 wherein the plurality of flow parameters sensed are temperature, static pressure and differential pressure of the flowable medium in the conduit system.

6. The system of claim 1 wherein said signal transfer unit receives power for operation when said activation surface of said data collection unit makes contact with said transfer surface of said transmission unit.

7. The system of claim 6 wherein all readings obtained are in real time.

8. The system of claim 7 wherein said transmission unit sends a digital signal with at least one flow parameter every 700 milliseconds when said activation surface is in contact with said data transmission surface.

9. The system of claim 1 wherein said at least one flow parameter is selected from a group consisting of temperature, static pressure and differential pressure.

10. The system of claim 1 further comprising a plurality of pairs of primary flow elements and associated signal processing and data transfer units, each of said pair being located at a predetermined identified position within the conduit system, to thereby provide flow parameters on the flowable medium in the conduit system obtained from said plurality of predetermined identified positions within said conduit system by said pairs of flow elements and associated signal processing and data transfer units.

11. The system of claim 1 wherein said at least one signal processing and data transfer unit further comprises a memory which can save a plurality of readings.

12. The system of claim 11 wherein said at least one signal processing unit further comprises a power source for taking and saving readings of said flow parameters in said memory for transfer of said saved parameters when said activation surface of said data collection unit touches said transfer surface of said signal processing and data transfer unit.

13. The system of claim 1 wherein said signal processing and data collection unit further comprises a processor and memory chip so that said signal processing and data collection unit can be programmed with information regarding said primary flow element to which said signal processing and data collection unit is attached and thereby process said digital signal.

14. The system of claim 1 wherein said at least one sensor and said at least one signal processing unit are located at a first position within the conduit system and said at least one sensor and said at least one signal processing unit have a probe which connects to a second position in the conduit system to provide simultaneous readings of a flow parameters from both said first position and said second position for the obtaining of readings from which a change of energy level of the system can be determined between the first and second location.

15. The system of claim 1 wherein the flowable medium can be any medium selected from the following group: water, air, gas and liquid.

16. The system of claim 10 wherein when said activation surface of said data collection unit makes contact with a data transfer surface of said signal processing and data transfer unit, said data collection unit first identifies said predetermined identified position within the conduit system and saves flow parameters obtained from said predetermined identified position as coming from said predetermined identified position.

17. The system of claim 10 wherein touching of each data transfer surface of each of said signal processing and transfer units at each predetermined identified position further comprises connecting said data transfer surface of each said signal processing and data transfer unit simultaneously to a communications network connected to said data collection unit, each flow parameter collection location having a unique identification, and wherein said data collection unit identifies and polls each signal processing and data transfer unit individually and saves said information obtained from each signal processing transfer unit in said data storage unit as being from the uniquely identified predetermined identified position.

18. The system of claim 10 wherein said data collection units and said signal processing and data transfer units use a one wire system of Dallas Semiconductors.

19. The system of claim 1 wherein said primary flow element is a head type of primary flow element.

20. A system for monitoring and reading parameters of a flowable medium within a system of conduits, which system has primary flow elements positioned at identified flow parameter collection locations, said system comprising:
a) at least one signal processing and data transfer unit comprising:
1) a sensor operatively connected to at least one of the primary flow elements for converting readings from the primary flow element to an analog electrical signal;
2) an analog to digital converter receptively connected to said sensor, for converting said analog signal received from said sensor to a digital signal; and
3) a transmission unit connected to said analog to digital converter for transmitting said digital signal upon activation of a data transfer surface of said transmission unit;
b) a data collection unit having an activation surface for activating said data transfer surface of said transmission unit and for receiving said digital signal from said transmission unit; and
c) a data storage unit operatively connected to the data collection unit for storing information within said digital signal concerning said at least on flow parameter.

21. The system of claim 20 in which said at least one signal processing and data transfer unit with a sensor operatively connected to at least one of the primary flow elements further comprises a signal processing and data transfer unit at each flow parameter collection location with at least one sensor of said signal processing transfer unit operatively connected to a primary flow element at said location.

22. The system of claim 21 wherein information concerning a flow parameter is gathered from each flow parameter collection location by touching said activation surface of said data collection unit to said data transfer surface of each signal processing and data transfer unit at each of the flow parameter collection locations.

23. The system of claim 22 wherein in when gathering said flow parameter information said data collection unit first identifies the location of the flow parameter collection location of said signal processing transfer unit and identifies the flow parameter information as having been obtained from the specifically identified location when saving said information to a flow parameter database.

24. The system of claim 21 wherein touching of each data transfer surface of each said signal processing and data transfer unit at each flow parameter collection location further comprises connecting said data transfer surface of each of said signal processing and data transfer units to a communications network connected to a master signal processor and data transfer unit, each flow parameter collection location having a unique identification, and wherein when said data collection unit connects to a transfer surface of said master signal processing and data transfer unit, said data collection unit identifies and polls each signal processing and data transfer unit on said communications network individually and saves said information obtained from each signal processing and data transfer unit in said data storage unit as being from said uniquely identified flow parameter location.

25. The system of claim 21 wherein said signal processing and data transfer units are retrofitted onto an existing system of conduits by being positioned at each flow parameter collection location with said sensors of each of said signal processing and data transfer units being operatively connected to primary flow elements at the respective flow parameter collection locations at which each is located.

26. A method for monitoring and collecting information on flow parameters of a flowable medium in a system of conduits, said method comprising the steps of:
a) programming a signal processing and data transfer unit with pre-selected data regarding a specified primary flow element of a conduit system; and
b) operatively attaching said signal processing and data transfer unit programmed with the pre-selected information at a flow parameter collection locations, which location has said specified primary flow element for which said signal processing and data collection unit was programmed;
c) providing power with a data collection unit to said signal processing and data transfer unit so that said signal processing and data transfer unit will generate readings; and
d) collecting readings generated by said signal processing and data collection unit regarding flow parameters from said data processing and signal transfer unit.

27. The method of claim 26 wherein the step of programming said signal processing and data transfer unit further comprises programming a plurality of signal processing and data transfer units with preselected data regarding a plurality of specified primary flow elements so that the programmed data on each signal processing and data transfer includes information regarding a unique one of each of said primary flow elements and said step of attaching said signal processing and data transfer unit comprises attaching it to said unique primary flow element for which it has been programmed.
